(19) United States
(12) Patent Application Publication
(10) Pub. No.: US 2018/0319394 A1
(43) Pub. Date: Nov. 8, 2018

(54) FAIL-SAFE SYSTEMS AND METHODS FOR VEHICLE PROXIMITY

(71) Applicants: Matthew Robert Phillipps, Santa Clarita, CA (US); Aaron Jacob Melzer, Trabuco Canyon, CA (US)

(72) Inventors: Matthew Robert Phillipps, Santa Clarita, CA (US); Aaron Jacob Melzer, Trabuco Canyon, CA (US)

(21) Appl. No.: 15/971,220

(22) Filed: May 4, 2018

Related U.S. Application Data
(60) Provisional application No. 62/501,543, filed on May 4, 2017.

(51) Int. Cl. B60W 30/09; G08G 1/16; G01S 5/00

(52) U.S. Cl. CPC B60W 30/09; G08G 1/161; B60W 2550/408; G01S 5/0072; B60W 2550/30; G08G 1/166

(57) ABSTRACT

Disclosed is a fail-safe system for vehicle proximity including, in some embodiments, an autonomous-vehicle control system onboard a vehicle, a brake system of the vehicle, and at least one onboard transceiver onboard the vehicle. An autonomous-vehicle control-system module can be configured with collision-determining logic. A brake-system module can be configured to slow down or stop the vehicle upon receiving a braking-process instruction from the control-system module. A transceiver module can be configured to receive signals from at least one external transmitter moving toward or away from the vehicle. The transceiver module can be configured to send to the control-system module proximity information for the external transmitter as it moves toward or away from the vehicle. The control-system module can be configured to send the braking-process instruction to the brake-system module upon processing the proximity information with the collision-determining logic and determining a collision is imminent with an external-transmitter carrier.

### CROSS-REFERENCE

This application claims the benefit of priority of U.S. Provisional Application No. 62/501,543, filed May 4, 2017, which is hereby incorporated by reference in its entirety into this application.

### FIELD

Provided herein are fail-safe systems and methods for vehicle proximity. In some embodiments, the fail-safe systems are embodied in autonomous vehicles to prevent collisions of various types.

### BACKGROUND

One of the largest technological barriers for safe autopilot navigation in self-driving vehicles is software that can perfectly predict human behavior. Due to the unpredictability of human drivers in non-self-driving vehicles, there exists a safety gap that necessitates drivers in self-driving vehicles “remain alert.” Despite this fact, as the technology for autopilot navigation becomes more common place, it is expected that many drivers will rely more heavily on their vehicles for safe autopilot navigation; consequently, it is expected that such drivers will become overconfident in their vehicles' abilities to keep them and their passengers safe. Therefore, what is needed are systems and methods that fill the existing safety gap and provide a fail-safe to prevent collisions between all road vehicles including self-driving and human-driven vehicles. Provided herein are systems and methods that address the foregoing.

### SUMMARY

Provided herein, in some embodiments, is a fail-safe system for vehicle proximity including an autonomous-vehicle control system onboard a vehicle, a brake system of the vehicle, and at least one onboard transceiver onboard the vehicle. The control system can include an autonomous-vehicle control-system module configured with collision-determining logic in a memory of the control system. The brake system can include a brake-system module in a memory of the brake system configured to slow down or stop the vehicle with one or more brakes in a braking process upon receiving a braking-process instruction from the control-system module. The onboard transceiver can include a transceiver module in a memory of the onboard transceiver configured to receive one or more signals from at least one external transmitter moving toward or away from the vehicle with respect to a reference frame of the vehicle. The transceiver module can be configured to send proximity information to the control-system module with respect to a proximity of the external transmitter moving toward or away from the vehicle. The control-system module can be configured to send the braking-process instruction to the brake-system module upon processing the proximity information with the collision-determining logic and determining a collision is imminent with a carrier of the external transmitter.

In such embodiments, the transceiver module, the control-system module, or a combination thereof can be configured to calculate rates-of-change with respect to the proximity of the external transmitter moving toward or away from the vehicle for impact-risk determinations.

In such embodiments, the onboard transceiver can be configured to transmit an instant location, a projected location, or both the instant location and the projected location of the vehicle to at least one external receiver moving toward or away from the vehicle.

In such embodiments, the at least one external transmitter and the at least one external receiver can be embodied in an external transceiver substantially similar to the onboard transceiver onboard the vehicle. The external transceiver can be onboard an additional vehicle.

In such embodiments, each transceiver of the onboard transceiver and the external transceiver can be configured to provide or otherwise transmit vehicle identification information, installation location information, or a combination thereof to the other transceiver. Such vehicle identification information can include, for example, a vehicle identification number, a size of the vehicle, and the like. Such installation location information can include, for example, a transceiver installation location at a front or a back of a vehicle. The transceiver module of the onboard transceiver onboard the vehicle can be configured to provide or otherwise transmit its vehicle identification information or installation location information to a transceiver module of the external transceiver onboard the additional vehicle. Likewise, the transceiver module of the external transceiver onboard the additional vehicle can be configured to provide or otherwise transmit its vehicle identification information or installation location information to the transceiver module of the onboard transceiver onboard the vehicle.

In such embodiments, the transceiver module of the onboard transceiver onboard the vehicle, the control-system module of the autonomous-vehicle control system onboard the vehicle, or a combination thereof can be configured to calculate positions for the vehicle and the additional vehicle, speeds for the vehicle and the additional vehicle, and trajectories for the vehicle and the additional vehicle. The transceiver module of the external transceiver onboard the additional vehicle, a control-system module of an autonomous-vehicle control system onboard the additional vehicle, or a combination thereof can be configured to calculate positions for the additional vehicle and the vehicle, speeds for the additional vehicle and the vehicle, and trajectories for the additional vehicle and the vehicle.

In such embodiments, the at least one external transmitter and the at least one external receiver are embodied in an external transceiver substantially similar to the onboard transceiver onboard the vehicle. The external transceiver can be on or in an object other than an additional vehicle.

In such embodiments, the external transceiver on or in the object can be configured to provide or otherwise transmit object information including a type of the object, a size of the object, installation location information, ora combination thereof. The type of the object can include, for example, a telephone pole or a traffic light. The size of the object can include, for example, the size of the telephone pole or the size of the traffic light. The installation location can include, for example, a transceiver installation location at a bottom, street-level accessible location on the telephone pole or the traffic light. The installation location can include, for example, a transceiver installation location midway up the telephone pole or the traffic light for less risk of public tampering. The installation location can include, for example, a transceiver installation location in the telephone pole or the traffic light for even less risk of public tampering. A transceiver module of the external transceiver onboard the object can be configured to provide or otherwise transmit the type of the object, the size of the object, the installation location information, or the combination thereof. The transceiver module of the onboard transceiver onboard the vehicle can be configured to receive the type of the object, the size of the object, the installation location information, or the combination thereof from the external transceiver onboard the object.

In such embodiments, the transceiver module of the onboard transceiver onboard the vehicle, the control-system module of the autonomous-vehicle control system onboard the vehicle, or a combination thereof can be configured to calculate positions for the vehicle and the object, speeds for the vehicle, and trajectories for the vehicle.

In such embodiments, the fail-safe system can further include a navigation system including a global positioning system (“GPS”) receiver. The navigation system can be configured to provide a navigation-system map including a location of the vehicle on the map and a location of the carrier of the external transmitter on the map.

Also provided herein, in some embodiments, is a method including instantiating an autonomous-vehicle control-system module, instantiating a brake-system module, and instantiating a transceiver module. The control-system module can be configured with collision-determining logic in a memory of an autonomous-vehicle control system onboard a vehicle. The brake-system module can be in a memory of a brake system and configured to commence a braking process to slow down or stop the vehicle with one or more brakes upon receiving a braking-process instruction from the control-system module. The transceiver module can be in a memory of at least one onboard transceiver onboard the vehicle and configured to receive one or more signals from at least one external transmitter moving toward or away from the vehicle with respect to a reference frame of the vehicle. The transceiver module can be configured to send proximity information to the control-system module with respect to a proximity of the external transmitter moving toward or away from the vehicle. The control-system module can be configured to send the braking-process instruction to the brake-system module upon processing the proximity information with the collision-determining logic and determining a collision is imminent with a carrier of the external transmitter.

In such embodiments, the transceiver module, the control-system module, or a combination thereof can be configured to calculate rates-of-change with respect to the proximity of the external transmitter moving toward or away from the vehicle for impact-risk determinations.

In such embodiments, the method can further comprise transmitting an instant location, a projected location, or both the instant location and the projected location of the vehicle with the onboard transceiver to at least one external receiver moving toward or away from the vehicle.

In such embodiments, the at least one external transmitter and the at least one external receiver can be embodied in an external transceiver substantially similar to the onboard transceiver onboard the vehicle. The external transceiver can be onboard an additional vehicle.

In such embodiments, the method can further comprise providing vehicle identification information for the vehicle, installation location information of the onboard transceiver on the vehicle, or a combination thereof with the transceiver module of the onboard transceiver on the vehicle to the external transceiver onboard the additional vehicle. Such vehicle identification information can include, for example, a vehicle identification number, a size of the vehicle, and the like. Such installation location information can include, for example, a transceiver installation location of the onboard transceiver on the vehicle at a front or a back of the vehicle.

In such embodiments, the method can further comprise calculating positions for the vehicle and the additional vehicle, speeds for the vehicle and the additional vehicle, and trajectories for the vehicle and the additional vehicle with the transceiver module of the onboard transceiver onboard the vehicle, the control-system module of the autonomous-vehicle control system onboard the vehicle, or a combination thereof.

In such embodiments, the at least one external transmitter and the at least one external receiver can be embodied in an external transceiver substantially similar to the onboard transceiver onboard the vehicle. The external transceiver can be on or in an object other than an additional vehicle.

In such embodiments, the method can further comprise receiving from the external transceiver on or in the object information including a type of the object, a size of the object, installation location information, or a combination thereof. The type of the object can include, for example, a telephone pole or a traffic light. The size of the object can include, for example, the size of the telephone pole or the size of the traffic light. The installation location can include, for example, a transceiver installation location at a bottom, street-level accessible location on the telephone pole or the traffic light. The installation location can include, for example, a transceiver installation location midway up the telephone pole or the traffic light for less risk of public tampering. The installation location can include, for example, a transceiver installation location in the telephone pole or the traffic light for even less risk of public tampering. The transceiver module of the onboard transceiver onboard the vehicle can be configured to receive the type of the object, the size of the object, the installation location information, or the combination thereof from the external transceiver onboard the object.

In such embodiments, the method can further comprise calculating positions for the vehicle and the object, speeds for the vehicle, and trajectories for the vehicle with the transceiver module of the onboard transceiver onboard the vehicle, the control-system module of the autonomous-vehicle control system onboard the vehicle, or a combination thereof.

In such embodiments, the method can further comprise instantiating a navigation-system module for a navigation system including a GPS receiver. The navigation-system module can be configured to provide a location of the vehicle on a navigation-system map and a location of the carrier of the external transmitter on the map.

These and other features of the concepts provided herein may be better understood with reference to the following drawings, description, and appended claims.

### DRAWINGS

FIG. 1 provides a schematic illustrating a system in accordance with some embodiments.

FIG. 2 provides a schematic illustrating one or more elements of the system in accordance with some embodiments.

### DESCRIPTION

Before certain concepts and some embodiments thereof are provided in greater detail, it should be understood by persons of ordinary skill in the art that the concepts and embodiments provided herein are not limiting. For example, it should be understood that one or more elements in any embodiment provided herein can vary. In view of the foregoing, one or more elements from one or more embodiments can be combined with elements of any other embodiments, substituted for elements of any other embodiments, or some combination thereof.

It should also be understood that the terminology used herein is for the purpose of describing the concepts and embodiments provided herein, and the terminology is not intended to be limiting. Unless indicated otherwise, ordinal numbers (e.g., first, second, third, etc.) are used to distinguish or identify different elements or steps respectively in a group of elements or group of steps. The ordinal numbers do not supply a serial or numerical limitation. For example, “first,” “second,” and “third” elements or steps need not necessarily appear in that order, and the embodiments need not necessarily be limited to the three elements or steps. Unless indicated otherwise, labels such as “left,” “right,” “front,” “back,” “top,” “bottom,” “forward,” “reverse,” “clockwise,” “counter clockwise,” “up,” “down,” or other similar terms such as “upper,” “lower,” “aft,” “fore,” “vertical,” “horizontal,” “proximal,” “distal,” and the like are not intended to imply, for example, any particular fixed location, orientation, or direction. Instead, such labels are used to reflect, for example, relative location, orientation, or directions. It should also be understood that the singular forms of “a,” “an,” and “the” include plural references unless the context clearly dictates otherwise.

Unless defined otherwise, all technical and scientific terms used herein have the same meaning as commonly understood by persons of ordinary skill in the art.

One of the largest technological barriers for safe autopilot navigation in self-driving vehicles is software than can perfectly predict human behavior. Due to the unpredictability of human drivers in non-self-driving vehicles, there exists a safety gap that necessitates drivers in self-driving vehicles “remain alert.” Despite this fact, as the technology for autopilot navigation becomes more common place, it is expected that many drivers will rely more heavily on their vehicles for safe autopilot navigation; consequently, it is expected that such drivers will become overconfident in their vehicles' abilities to keep them and their passengers safe. Therefore, what is needed are systems and methods that fill the existing safety gap and provide a fail-safe to prevent collisions between all road vehicles including self-driving and human-driven vehicles. Provided herein are systems and methods that address the foregoing.

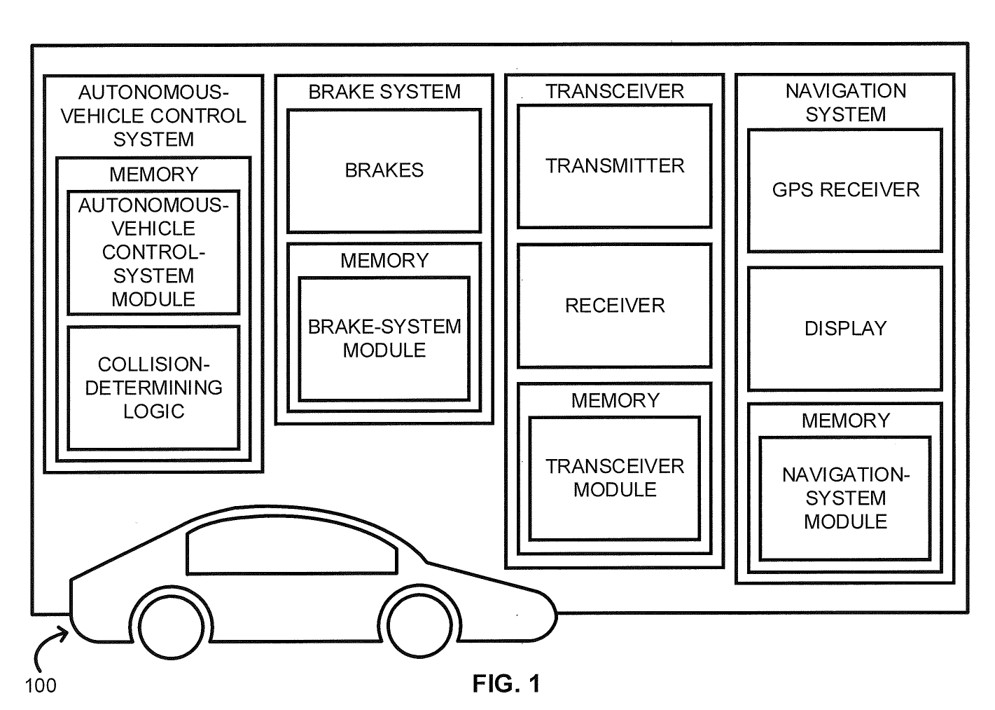

FIG. 1 provides a schematic illustrating a system 100 in accordance with some embodiments that addresses the foregoing.

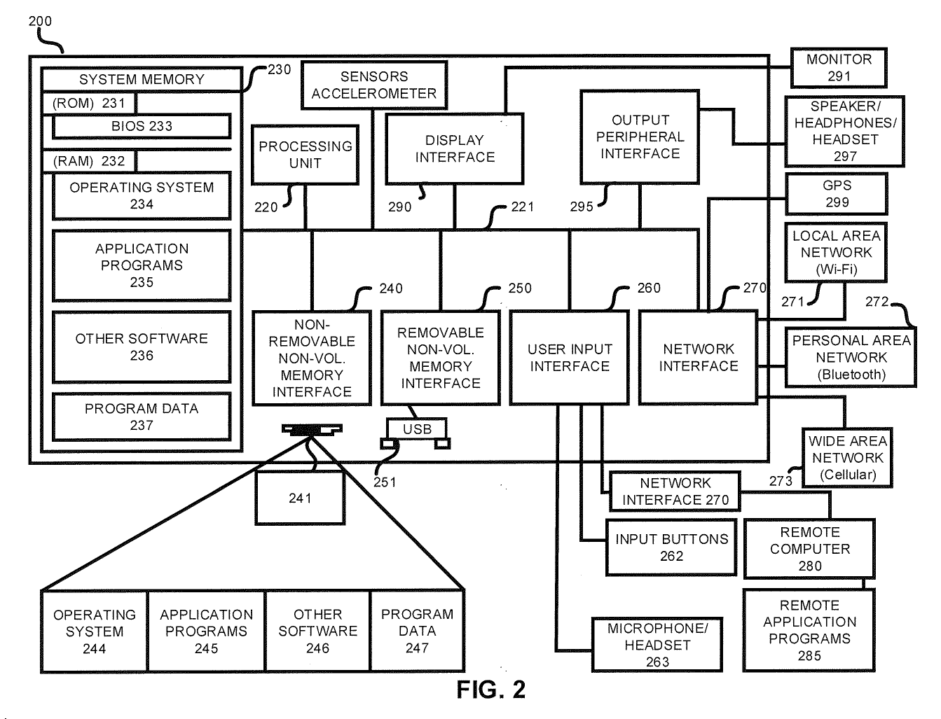

As shown in FIG. 1, the system 100 can include an autonomous-vehicle control system onboard a vehicle, a brake system of the vehicle, at least one onboard transceiver onboard the vehicle, and an optional navigation system. The autonomous-vehicle control system can include a memory including an autonomous-vehicle control system module and collision-determining logic. The brake system can include one or more brakes and memory, which, in turn, can include a brake-system module. The transceiver can include a transmitter, a receiver, and memory, which, in turn, can include a transceiver module. The navigation system, when present, can include a GPS receiver (see GPS 299 in FIG. 2), a display, and memory, which, in turn, can include a navigation system module. It should be understood that the configuration of the system 100 is merely an example as, for example, the memory and the modules stored therein need not be configured as shown in FIG. 1.

In some embodiments, the system or vehicle proximity fail-safe can include the autonomous-vehicle control system onboard the vehicle, the brake system of the vehicle, and the at least one onboard transceiver onboard the vehicle. The control system can include the autonomous-vehicle control-system module configured with the collision-determining logic in the memory of the control system. The brake system can include the brake-system module in the memory of the brake system configured to slow down or stop the vehicle with one or more brakes in a braking process upon receiving a braking-process instruction from the control-system module. The onboard transceiver can include the transceiver module in the memory of the onboard transceiver configured to receive one or more signals from at least one external transmitter moving toward or away from the vehicle with respect to a reference frame of the vehicle. The transceiver module can be configured to send proximity information to the control-system module with respect to a proximity of the external transmitter moving toward or away from the vehicle. The control-system module can be configured to send the braking-process instruction to the brake-system module upon processing the proximity information with the collision-determining logic and determining a collision is imminent with a carrier of the external transmitter.

The vehicle proximity fail-safe can use a transceiver (e.g., “Device A”) and a separate transmitter (e.g., “Device B”) to identify vehicles in proximity to the vehicle with Device A installed. Device A can be installed in any vehicle, human-driven or self-driving, and connected to the vehicle's braking system, autonomous-vehicle control system (e.g., “autopilot system”), or a combination thereof.

Device A can be one or more active modules installed on a single vehicle, which can be configured to transmit the vehicle's location and receive signals from other vehicles in close proximity with Device B installed. In one instance, Device A can be connected to a human-driven braking system and act as a fail-safe control to apply emergency braking. In another instance, Device A can be connected to the self-driving vehicle's autopilot system such that it can provide information about the proximity of other vehicles. In both cases, Device A can be configured to perform rate-of-change calculations to determine risk of impact with vehicles in close proximity. Device A can be encoded with positional data as to where it is installed on the vehicle, such as a front or a back of the vehicle, along with vehicle identification information such the vehicle identification number, a size of the vehicle, and the like.

Device B can include one or more modules installed on a single vehicle, or an object, which can be an active or passive device that transmits a signal indicating its position or location. Device B can be encoded with positional or other information. When installed on a vehicle, a tag can be configured to provide vehicle identification information, information about the devices position in the vehicle, such as, a front section or a back section of the vehicle, size of the vehicle, or other information. When installed on an object, the tag can be configured to provide information about the type of object, such as a telephone pole, a traffic light, a position on the object, a size of the object, and the like.

There are several methods by which Device A and B can cooperate with each other to form the fail-safe system. In some embodiments, information from a navigation system map can be integrated into the fail-safe system. In addition, the navigation system module of the fail-safe can be integrated with an existing navigation system to provide a location of one or more vehicles or objects on a navigation-system map.

Device A can be a single module installed in a vehicle (e.g., “Vehicle A”), and Device B can be a single module installed in an additional vehicle (e.g., “Vehicle B”) or an object (e.g., “Object B”). Using multiple measurements of the distance between the two vehicles or Vehicle A and Object B, the system can be configured to generate a model of trajectory, speed, and position of Vehicle A and Vehicle B (or Object B) relative to each other.

Device A can be a single module installed in Vehicle A, and Device B can include two modules installed in Vehicle B or Object B. Device B can be installed such that one module of the two modules is installed in the front and the other module of the two modules is installed in the back of Vehicle B or Object B. Using measurements of the distance between the module of Device A and the two modules of Device B, as well as triangulation techniques, the system can be configured to determine trajectories, speeds, and positions of Vehicle A and Vehicle B or Object B relative to each other. The measurements and triangulation techniques also allow the system to determine the projected size of Vehicle B or Object B.

Device A can include two modules installed in Vehicle A such that one module of the two modules is installed in the front and the other module of the two modules is installed in the back of Vehicle A. Device B can also include two modules installed in Vehicle B or Object B with a substantially similar configuration. In operation of the system, measurements of the distance between the front module of Device A and the two modules of Device B can be used by the system for triangulation. Measurements of the distance between the back module of Device A and the two modules of Device B can also be used by the system for triangulation. A combination of triangulations can provide information to the system for determining trajectories, speeds, and positions of Vehicle A and Vehicle B or Object B relative to each other. The foregoing also allows the fail-safe system to determine a projected size of both Vehicle A and Vehicle B or Object B.

Radio Frequency Identification (“RFID”), Bluetooth®, Wireless Local Area Network (“WLAN”), or other wireless communication technologies can be used in Devices A and B to accomplish system and methods provided herein.

In some embodiments, for example, an RFID can be used for Devices A and B. Either an Active Reader Passive Tag (“ARPT”) system or Active Reader Active Tag (“ARAT”) system can be used in such embodiments. For example, in ARPT systems, Device A can be configured as an active reader while Device B can be configured as a passive tag.

There are several advantages to Device A as the active reader and Device B as the passive tag. For example, Device B as a passive tag can be low cost. In addition, Device B can be sufficiently small to be integrated into a sticker for placement on an outside (back) of a vehicle. Also, by using ultra-high frequency (“UHF”) bands, the transmission range can be greater than 30 meters.

FIG. 2 provides a schematic illustrating one or more elements of the system 100 in accordance with some embodiments.

FIG. 2 illustrates a computer system 200 that can be, wholly or partially, part of one or more of the fail-safe systems or one or more of the devices in accordance with some embodiments. With reference to FIG. 2, components of the computer system 200 can include, but are not limited to, a processing unit 220 having one or more processing cores, a system memory 230, and a system bus 221 that couples various system components including the system memory 230 to the processing unit 220. The system bus 221 can be any of several types of bus structures selected from a memory bus or memory controller, a peripheral bus, and a local bus using any of a variety of bus architectures. For example, the computer system 200 can be, in whole or in part, at least part of an embedded system. Furthermore, different parts of the computer system 200 can simultaneously correspond to different parts of the embedded system such as the autonomous-vehicle control system, the brake system, or the optional navigation system.

The computer system 200 can include any of a variety of computer-readable media, or “storage media.” Computer-readable media can be any available media accessible by the computer system 200 and includes volatile media or non-volatile media, as well as removable media or non-removable media. By way of example, not limitation, computer-readable media stores information such as computer-readable instructions, executable software, software used to facilitate certain algorithms, or data structures or other data, which includes, for example, the autonomous-vehicle control system module, the collision-determining logic, the brake system module, the transceiver module, or the GPS. Computer-readable media includes, but is not limited to, random-access memory (“RAM”), read-only memory (“ROM”), EEPROM, flash memory or another memory technology, CD-ROM, digital versatile disks (“DVDs”) or other optical-disk storage disks, magnetic cassettes, magnetic tape, magnetic disk storage or other magnetic storage devices, or any other tangible computer-readable medium that can be used to store desired information for subsequent access by the computer system 200. Transitory media such as wireless channels are not included in the computer-readable media.

The system memory 230 includes computer-readable media in the form of volatile or non-volatile memory such as ROM 231 or RAM 232. A basic input-output system 233 (“BIOS”) containing the basic routines for transferring information between elements within the computer system 200 such as during start-up can be stored in ROM 231. RAM 232 can contain data or software immediately accessible to or presently being operated on by the processing unit 220. By way of example, not limitation, FIG. 2 illustrates that RAM 232 can include at least a portion of the operating system 232, application programs 235, other executable software 236, or program data 237, which includes, for example, the autonomous-vehicle control system module, the collision-determining logic, the brake system module, the transceiver module, or the GPS.

The computer system 200 can also include other removable or non-removable media or volatile or non-volatile media. By way of example only, FIG. 2 illustrates a solid-state memory 241. Other removable or non-removable media or volatile or non-volatile media that can be used in the computer system 200 include, but are not limited to, universal serial bus (“USB”) devices, flash memory cards, solid-state RAM, solid-state ROM, and the like. The solid-state memory 241 is typically connected to the system bus 221 through a non-removable memory interface such as interface 240, and USB device 251 is typically connected to the system bus 221 by a removable memory interface such as interface 250.

The computer-readable media discussed above provide storage of computer-readable instructions, executable software, or data structures or other data for the computer system 200. In FIG. 2, for example, the solid-state memory 241 is illustrated for storing operating system 244, application programs 245, other executable software 246, and program data 247. Note that these components can either be the same as or different from operating system 234, application programs 235, other executable software 236, and program data 237. Operating system 244, application programs 245, other executable software 246, and program data 247 are given different numbers here to illustrate that, at a minimum, they are different copies.

A user can optionally enter commands and information into the computer system 200 through an input device such as a keyboard, a touchscreen, one or more software or hardware input buttons 262, a microphone 263, a pointing device or scrolling input component such as a mouse, a trackball, or a touch pad. The microphone 263 can cooperate with speech-recognition software. These and other input devices can be connected to the processing unit 220 through a user input interface 260 that is coupled to the system bus 221. These and other input devices can alternatively be connected by other interface or bus structures such as a parallel port, a game port, or USB. A display monitor 291 or other type of display screen device (e.g., a display disposed in a vehicle's console) can be connected to the system bus 221 via an interface such as a display interface 290. In addition to the monitor 291, computer devices can also include other peripheral output devices such as one or more speakers 297 (e.g., a vehicle's speakers such as those used for audio entertainment) or other output devices, which can be connected through an output peripheral interface 295.

The computer system 200 can operate in a networked environment using logical connections to one or more remote computers or client devices such as a remote computer system 280. The remote computer system 280 can be a personal computer, a hand-held device (e.g., a smart phone, a diagnostic system, etc.), a server, a router, a network PC, a peer device, or some other network node (e.g., another vehicle, optionally by way of its transceiver). Typically, the remote computer system 200 includes many or all of the elements described above relative to the computer system 200. The logical connections depicted in FIG. 2 can include a personal area network (“PAN”) 272 (e.g., Bluetooth®), a local area network (“LAN”) 271 (e.g., Wi-Fi), or a wide area network (“WAN”) 273 (e.g., cellular network).

When used in a LAN networking environment, the computer system 200 can be connected to the LAN 271 through a network interface or adapter 270, which can be, for example, a Bluetooth® or Wi-Fi adapter. When used in a WAN networking environment (e.g., Internet), the computer system 200 can include some means for establishing communications over the WAN 273. With respect to mobile telecommunication technologies, for example, a radio interface, which can be internal or external, can be connected to the system bus 221 via the network interface 270 or some other appropriate mechanism. In a networked environment, other software depicted relative to the computer system 200, or portions thereof, can be stored in the remote memory storage device. By way of example, not limitation, FIG. 2 illustrates remote application programs 285 as residing on a remote computer device 280. It will be appreciated that the network connections shown are examples, as other means of establishing a communications link between the computer devices can alternatively be used.

Another device that can be coupled to bus 221 is a power supply such as a DC-power supply. The DC-power supply can be a car battery, a fuel cell, or a similar DC-power source that needs to be recharged on a periodic basis such as by way of charged by way of an alternator including a rectifier.

Note, an application described herein includes, but is not limited to, software applications, mobile apps, or programs that are part of an operating system application. Some portions of this description are presented in terms of algorithms and symbolic representations of operations on data bits within a computer memory. Algorithmic or symbolic representations are the means used by those skilled in the data processing arts to most effectively convey the substance of their work to others skilled in the art. An algorithm is a self-consistent sequence of steps leading to a desired result. The steps can require physical manipulations of physical quantities. These quantities take the form of electrical or magnetic signals capable of being stored, transferred, combined, compared, or otherwise manipulated. It has proven convenient at times, principally for reasons of common usage, to refer to these signals as bits, values, elements, symbols, characters, terms, numbers, or the like. These algorithms can be written in a number of different software programming languages such as C, C+, or other similar languages. Also, an algorithm can be implemented with lines of code in software, configured logic gates in software, or a combination of both. In an embodiment, the logic consists of electronic circuits that follow the rules of Boolean Logic, software that contain patterns of instructions, or any combination of both.

It should be borne in mind, however, that all of these and similar terms are to be associated with the appropriate physical quantities and are merely convenient labels applied to these quantities. Unless specifically stated otherwise as apparent from the above discussions, it is appreciated that throughout the description, discussions utilizing terms such as “processing” or “computing” or “calculating” or “determining” or “displaying” or the like, refer to the action and processes of a computer system, or similar electronic computer device, that manipulates and transforms data represented as physical (electronic) quantities within the computer system's registers and memories into other data similarly represented as physical quantities within the computer system memories or registers, or other such information storage, transmission or display devices.

Many functions performed by electronic hardware components can be duplicated by software emulation. Thus, a software program written to accomplish those same functions can emulate the functionality of the hardware components in input-output circuitry.

The foregoing represents an advance in collision-prevention technology for at least autonomous vehicles. Because autonomous vehicles involve one or more computer-related technologies, the advance in collision-prevention technology also involves one or more computer-related technologies, thereby overcoming a technical problem thereof, particularly overreliance on autopilot navigation in such autonomous vehicles.

While the foregoing concepts and embodiments thereof have been provided in considerable detail, it is not the intention of the applicant(s) for the concepts and embodiments provided herein to be limiting. Additional adaptations and/or modifications are possible, and, in broader aspects, these adaptations and/or modifications are also encompassed. Accordingly, departures can be made from the foregoing concepts and embodiments without departing from the scope afforded by the following claims, which scope is only limited by the claims when appropriately construed.

What is claimed is:

1. A fail-safe system for vehicle proximity, comprising:
an autonomous-vehicle control system onboard a vehicle,
wherein the control system includes an autonomous-vehicle control-system module configured with collision-determining logic in a memory of the control system;
a brake system of the vehicle configured to slow down or stop the vehicle with one or more brakes in a braking process,
wherein a brake-system module in a memory of the brake system is configured to commence the braking process upon receiving a braking-process instruction from the control-system module;
at least one onboard transceiver onboard the vehicle configured to receive one or more signals from at least one external transmitter moving toward or away from the vehicle with respect to a reference frame of the vehicle,
wherein the onboard transceiver includes a transceiver module in a memory of the onboard transceiver configured to send proximity information to the control-system module with respect to a proximity of the external transmitter moving toward or away from the vehicle, and
wherein the control-system module is configured to send the braking-process instruction to the brake-system module upon processing the proximity information with the collision-determining logic and determining a collision is imminent with a carrier of the external transmitter.

2. The fail-safe system of claim 1,
wherein the transceiver module, the control-system module, or a combination thereof is configured to calculate rates-of-change with respect to the proximity of the external transmitter moving toward or away from the vehicle for impact-risk determinations.

3. The fail-safe system of claim 1,
wherein the onboard transceiver is configured to transmit an instant location, a projected location, or both the instant location and the projected location of the vehicle to at least one external receiver moving toward or away from the vehicle.

4. The fail-safe system of claim 3,
wherein the at least one external transmitter and the at least one external receiver are embodied in an external transceiver substantially similar to the onboard transceiver onboard the vehicle, and
wherein the external transceiver is onboard an additional vehicle.

5. The fail-safe system of claim 4,
wherein each transceiver of the onboard transceiver and the external transceiver is configured to provide vehicle identification information, installation location information, or a combination thereof to the other transceiver.

6. The fail-safe system of claim 5,
wherein the transceiver module of the onboard transceiver onboard the vehicle, the control-system module of the autonomous-vehicle control system onboard the vehicle, or a combination thereof is configured to calculate positions for the vehicle and the additional vehicle, speeds for the vehicle and the additional vehicle, and trajectories for the vehicle and the additional vehicle, and
wherein a transceiver module of the external transceiver onboard the additional vehicle, a control-system module of an autonomous-vehicle control system onboard the additional vehicle, or a combination thereof is configured to calculate positions for the additional vehicle and the vehicle, speeds for the additional vehicle and the vehicle, and trajectories for the additional vehicle and the vehicle.

7. The fail-safe system of claim 1,
wherein the at least one external transmitter and the at least one external receiver are embodied in an external transceiver substantially similar to the onboard transceiver onboard the vehicle, and
wherein the external transceiver is on or in an object other than an additional vehicle.

8. The fail-safe system of claim 1,
wherein the external transceiver on or in the object is configured to provide object information including a type of the object, a size of the object, installation location information, or a combination thereof.

9. The fail-safe system of claim 1,
wherein the transceiver module of the onboard transceiver onboard the vehicle, the control-system module of the autonomous-vehicle control system onboard the vehicle, or a combination thereof is configured to calculate positions for the vehicle and the object, speeds for the vehicle, and trajectories for the vehicle.

10. The fail-safe system of claim 1, further comprising
a navigation system including a global positioning system (“GPS”) receiver, wherein the navigation system is configured to provide a navigation-system map including a location of the vehicle on the map and a location of the carrier of the external transmitter on the map.

11. A non-transitory machine-readable storage medium having stored thereon a computer program comprising a set of instructions that cause a fail-safe system for vehicle proximity to perform one or more steps, comprising:
instantiating an autonomous-vehicle control-system module configured with collision-determining logic in a memory of an autonomous-vehicle control system onboard a vehicle;
instantiating a brake-system module in a memory of the brake system configured to commence a braking process to slow down or stop the vehicle with one or more brakes upon receiving a braking-process instruction from the control-system module;
instantiating a transceiver module in a memory of at least one onboard transceiver onboard the vehicle configured to
receive one or more signals from at least one external transmitter moving toward or away from the vehicle with respect to a reference frame of the vehicle, and
send proximity information to the control-system module with respect to a proximity of the external transmitter moving toward or away from the vehicle,
wherein the control-system module is configured to send the braking-process instruction to the brake-system module upon processing the proximity information with the collision-determining logic and determining a collision is imminent with a carrier of the external transmitter.

12. The machine-readable storage medium of claim 11,
wherein the transceiver module, the control-system module, or a combination thereof is configured to calculate rates-of-change with respect to the proximity of the external transmitter moving toward or away from the vehicle for impact-risk determinations.

13. The machine-readable storage medium of claim 11, further comprising transmitting an instant location, a projected location, or both the instant location and the projected location of the vehicle with the onboard transceiver to at least one external receiver moving toward or away from the vehicle.

14. The machine-readable storage medium of claim 13,
wherein the at least one external transmitter and the at least one external receiver are embodied in an external transceiver substantially similar to the onboard transceiver onboard the vehicle, and
wherein the external transceiver is onboard an additional vehicle.

15. The machine-readable storage medium of claim 14, further comprising providing vehicle identification information for the vehicle, installation location information of the onboard transceiver on the vehicle, or a combination thereof with the transceiver module to the external transceiver onboard the additional vehicle.

16. The machine-readable storage medium of claim 15, further comprising calculating positions for the vehicle and the additional vehicle, speeds for the vehicle and the additional vehicle, and trajectories for the vehicle and the additional vehicle with the transceiver module of the onboard transceiver onboard the vehicle, the control-system module of the autonomous-vehicle control system onboard the vehicle, or a combination thereof.

17. The machine-readable storage medium of claim 11,
wherein the at least one external transmitter and the at least one external receiver are embodied in an external transceiver substantially similar to the onboard transceiver onboard the vehicle, and
wherein the external transceiver is on or in an object other than an additional vehicle.

18. The machine-readable storage medium of claim 11, further comprising receiving from the external transceiver on or in the object information including a type of the object, a size of the object, installation location information, or a combination thereof.

19. The machine-readable storage medium of claim 11, further comprising calculating positions for the vehicle and the object, speeds for the vehicle, and trajectories for the vehicle with the transceiver module of the onboard transceiver onboard the vehicle, the control-system module of the autonomous-vehicle control system onboard the vehicle, or a combination thereof.

20. The machine-readable storage medium of claim 11, further comprising instantiating a navigation-system module for a navigation system including a global positioning system (“GPS”) receiver,
wherein the navigation-system module is configured to provide a location of the vehicle on a navigation-system map and a location of the carrier of the external transmitter on the map.
